(19) United States
(12) Patent Application Publication
(10) Pub. No.: US 2026/0116366 A1
(43) Pub. Date: Apr. 30, 2026

(54) ELECTRIC BRAKE SYSTEM AND CONTROL METHOD THEREOF

(71) Applicant: HL MANDO CORPORATION, Pyeongtaek-si (KR)

(72) Inventors: Yeonseong KIM, Pyeongtaek-si (KR); Kiwon KANG, Pyeongtaek-si (KR)

(21) Appl. No.: 19/059,761

(22) Filed: Feb. 21, 2025

(30) Foreign Application Priority Data
Oct. 30, 2024 (KR) 10-2024-0150872

(51) Int. Cl. B60T 13/68; B60T 8/94; B60T 13/74

(52) U.S. Cl. CPC B60T 13/686; B60T 8/94; B60T 13/745; B60T 2270/413

(57) ABSTRACT

An electric brake system includes a hydraulic pressure supply device configured to generate hydraulic pressure of a pressurized medium, a hydraulic control unit provided between the hydraulic pressure supply device and a plurality of wheel cylinders and configured to transmit the hydraulic pressure generated by the hydraulic pressure supply device to the plurality of wheel cylinders, and an auxiliary brake module configured to provide hydraulic pressure to a first wheel cylinder and a second wheel cylinder among the plurality of wheel cylinders.

### CROSS-REFERENCE TO RELATED APPLICATIONS

This application claims the priority of Korean Patent Application No. 10-2024-0150872 filed on Oct. 30, 2024, in the Korean Intellectual Property Office, the disclosure of which is incorporated herein by reference.

### BACKGROUND

### Field

The present disclosure relates to an electric brake system and a control method thereof.

### Description of the Related Art

Vehicles are essentially equipped with a brake system to perform braking, and various types of brake systems are proposed to ensure the safety of drivers and passengers.

Conventionally, a brake system mainly uses a method of supplying hydraulic pressure required for braking to a wheel cylinder using a mechanically connected booster when the driver steps on a brake pedal. However, as a market demand for implementing various braking functions in detail in response to an operating environment of a vehicle has increased, recently, an electric brake system has become widespread, which receives a driver's braking intention as an electrical signal from a pedal displacement sensor for detecting the displacement of a brake pedal when the driver steps on the brake pedal, and operates a hydraulic pressure supply device based on the electrical signal to supply the hydraulic pressure required for braking to the wheel cylinder.

The electric brake system receives, as the electrical signal, braking determination when the driver operates the brake pedal or the vehicle autonomously travels, and based on the electrical signal, the hydraulic pressure supply device is electrically operated and controlled to form hydraulic pressure required for braking and transmit the hydraulic pressure to the wheel cylinder.

While the electric brake system and the control method thereof are electrically operated and controlled, it is possible to implement complex and diverse braking operations. However, when a technical problem occurs in an electrical component, the hydraulic pressure required for braking may not be stably formed, which may threaten the safety of vehicle occupants.

Therefore, the electric brake system will enter an abnormal operating mode when one component fails or becomes uncontrollable, and in this case, a mechanism is required to directly link the brake pedal operation of the driver to the wheel cylinder.

In addition, a method is required to ensure stable braking of the vehicle even before the driver operates the brake pedal after the electric brake system enters an abnormal operating mode.

In addition, a method is required to perform active braking, such as an anti-lock brake system (ABS) mode of the vehicle, to ensure stable braking of the vehicle and stable behavior of the vehicle even in abnormal operation modes of the electric brake system.

### SUMMARY

An object of the present disclosure is to provide an electric brake system and a control method thereof capable of effectively performing braking even in various operating situations of a vehicle.

Another object of the present disclosure is to provide an electric brake system and a control method thereof with improved braking performance and operational reliability.

Still another object of the present disclosure is to provide an electric brake system and a control method thereof capable of performing various braking operation modes through simple structure and operation.

Still another object of the present disclosure is to provide an electric brake system and a control method thereof capable of improving assemblability and productivity of a product and reducing manufacturing costs.

Still another object of the present disclosure is to provide an electric brake system and a control method thereof capable of reducing suction resistance of a pump of an auxiliary brake module.

According to one aspect of the present disclosure, there is provided an electric brake system including: a hydraulic pressure supply device configured to generate hydraulic pressure of a pressurized medium; a hydraulic control unit provided between the hydraulic pressure supply device and a plurality of wheel cylinders and configured to transmit the hydraulic pressure generated by the hydraulic pressure supply device to the plurality of wheel cylinders; and an auxiliary brake module configured to provide hydraulic pressure to a first wheel cylinder and a second wheel cylinder among the plurality of wheel cylinders, in which the auxiliary brake module may include a first accumulator configured to temporarily store the pressurized medium discharged from the first wheel cylinder, a first auxiliary supply flow path to which a first connection flow path connecting the hydraulic control unit and the first wheel cylinder is connected and to which the first accumulator is connected, a first pump configured to pressurize the pressurized medium supplied through the first auxiliary supply flow path, a motor configured to operate the first pump, a first auxiliary flow path configured to transmit the pressurized medium pressurized by the first pump to the first wheel cylinder, a first auxiliary supply valve provided in the first auxiliary supply flow path and configured to control the supply of the pressurized medium supplied to the first pump, and a first pressure regulating valve configured to regulate pressure of the first auxiliary flow path.

The electric brake system may further include a control circuit configured to close the first pressure regulating valve, open the first auxiliary supply valve, and control the motor to operate the first pump based on receiving a braking request from an external controller while the hydraulic pressure supply device is inoperable.

The pressurized medium stored in the first accumulator may be supplied to the first pump according to closing of the first pressure regulating valve and opening of the first auxiliary supply valve.

The pressurized medium supplied to the first pump through the first connection flow path may be further supplied according to the closing of the first pressure regulating valve and the opening of the first auxiliary supply valve.

The control circuit may open the first pressure regulating valve, close the first auxiliary supply valve, and control the motor to stop the operation of the first pump, based on receiving a braking request through a brake pedal while the hydraulic pressure supply device is inoperable.

The pressurized medium discharged from the first wheel cylinder may be temporarily stored in the first accumulator according to the first pressure regulating valve being in an open state and the first auxiliary supply valve being in a closed state.

The auxiliary brake module may further include a second accumulator configured to temporarily store the pressurized medium discharged from the second wheel cylinder, a second auxiliary supply flow path to which a second connection flow path connecting the hydraulic control unit and the second wheel cylinder is connected and to which the second accumulator is connected, a second pump configured to pressurize the pressurized medium supplied through the second auxiliary supply flow path, a second auxiliary flow path configured to transmit the pressurized medium pressurized by the second pump to the second wheel cylinder, a second auxiliary supply valve provided in the second auxiliary supply flow path and configured to control the supply of the pressurized medium supplied to the second pump, and a second pressure regulating valve configured to regulate the pressure of the second auxiliary flow path, and the second pump may be operated by the motor.

The electric brake system may further include a control circuit configured to close the second pressure regulating valve, open the second auxiliary supply valve, and control the motor to operate the second pump based on receiving a braking request from an external controller while the hydraulic pressure supply device is inoperable.

The pressurized medium stored in the second accumulator may be supplied to the second pump according to closing of the second pressure regulating valve and opening of the second auxiliary supply valve.

The pressurized medium supplied to the second pump through the second connection flow path may be further supplied according to the closing of the second pressure regulating valve and the opening of the second auxiliary supply valve.

The control circuit may open the second pressure regulating valve, close the second auxiliary supply valve, and control the motor to stop the operation of the second pump, based on receiving a braking request through a brake pedal while the hydraulic pressure supply device is inoperable.

The pressurized medium discharged from the second wheel cylinder may be temporarily stored in the second accumulator according to the second pressure regulating valve being in an open state and the second auxiliary supply valve being in a closed state.

The electric brake system may further include an integrated master cylinder including a first master piston provided to be displaceable by operation of a brake pedal, a first master chamber whose volume is variable by the displacement of the first master piston, a second master piston provided to be displaceable by the displacement of the first master piston or hydraulic pressure of the first master chamber, and a second master chamber whose volume is variable by the displacement of the second master piston, in which the first connection flow path may connect the first master chamber and the first wheel cylinder, and the second connection flow path may connect the second master chamber and the second wheel cylinder.

The electric brake system may further include: a reservoir; a first reservoir flow path connecting the first master chamber and the reservoir; and a second reservoir flow path connecting the second master chamber and the reservoir.

The first pressure regulating valve may be provided in the first connection flow path, and the second pressure regulating valve may be provided in the second connection flow path.

According to another aspect of the present disclosure, there is provided a control method of an electric brake system including a hydraulic pressure supply device configured to generate hydraulic pressure of a pressurized medium, a hydraulic control unit provided between the hydraulic pressure supply device and a plurality of wheel cylinders and configured to transmit the hydraulic pressure generated by the hydraulic pressure supply device to the plurality of wheel cylinders, a first accumulator configured to temporarily store pressurized medium discharged from a first wheel cylinder among the plurality of wheel cylinders, a first auxiliary supply flow path to which a first connection flow path connecting the hydraulic control unit and the first wheel cylinder is connected and to which the first accumulator is connected, a first pump configured to pressurize the pressurized medium supplied through the first auxiliary supply flow path, a motor configured to operate the first pump, a first auxiliary flow path configured to transmit the pressurized medium pressurized by the first pump to the first wheel cylinder, a first auxiliary supply valve provided in the first auxiliary supply flow path and configured to control the supply of the pressurized medium supplied to the first pump, and a first pressure regulating valve configured to regulate the pressure of the first auxiliary flow path, the control method including: receiving a braking request from an external controller while the hydraulic pressure supply device is inoperable; and closing the first pressure regulating valve, opening the first auxiliary supply valve, and controlling the motor to operate the first pump, based on the braking request.

The pressurized medium stored in the first accumulator may be supplied to the first pump according to closing of the first pressure regulating valve and opening of the first auxiliary supply valve.

The electric brake system may further include a second accumulator configured to temporarily store the pressurized medium discharged from a second wheel cylinder among the plurality of wheel cylinders, a second auxiliary supply flow path to which a second connection flow path connecting the hydraulic control unit and the second wheel cylinder is connected and to which the second accumulator is connected, a second pump configured to pressurize the pressurized medium supplied through the second auxiliary supply flow path, a second auxiliary flow path configured to transmit the pressurized medium pressurized by the second pump to the second wheel cylinder, a second auxiliary supply valve provided in the second auxiliary supply flow path and configured to control the supply of the pressurized medium supplied to the second pump, and a second pressure regulating valve configured to regulate the pressure of the second auxiliary flow path.

The control method may further include closing the second pressure regulating valve, opening the second auxiliary supply valve, and controlling the motor to operate the second pump based on the braking request.

The pressurized medium discharged from the first wheel cylinder may be temporarily stored in the first accumulator according to the first pressure regulating valve being in an open state and the first auxiliary supply valve being in a closed state, and the pressurized medium discharged from the second wheel cylinder may be temporarily stored in the second accumulator according to the second pressure regulating valve being in an open state and the second auxiliary supply valve being in a closed state.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a hydraulic circuit diagram illustrating an electric brake system according to one exemplary embodiment;

FIG. 2 is a block diagram illustrating a configuration of a control circuit of an electric brake system according to one embodiment; and

FIG. 3 is a flowchart of a control operation of an electric brake system according to one exemplary embodiment.

### DETAILED DESCRIPTION OF THE EMBODIMENT

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

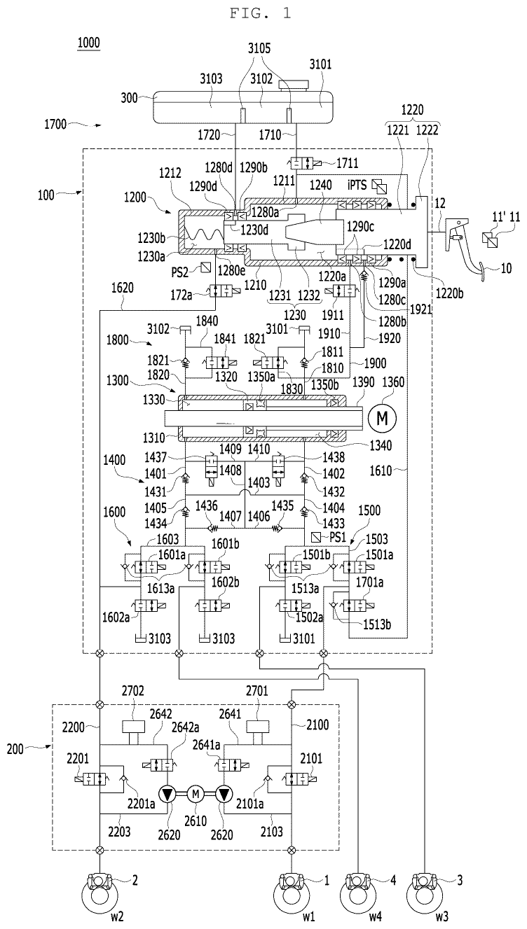

FIG. 1 is a hydraulic circuit diagram illustrating an electric brake system according to one exemplary embodiment.

Referring to FIG. 1, an electric brake system 1000 may include a main brake module (also referred to as an integrated dynamic brake (IDB) module) 100 that is operated and controlled mechanically and/or electronically, an auxiliary brake module (also referred to as an auxiliary brake) 200 that is provided between the main brake module 100 and a plurality of wheel cylinders 1, 2, 3, and 4 and operates when the main brake module 100 is inoperable, a reservoir 300 in which a pressurized medium is stored, a first control circuit 4100 that controls the main brake module 100, and a second control circuit 4500 that controls the auxiliary brake module 200.

The main brake module 100 may include an integrated master cylinder 1200 that provides a reaction force according to a stepping force of a brake pedal 10 to the driver and pressurizes and discharges a pressurized medium accommodated inside, a hydraulic pressure supply device 1300 that receives a braking intention of a driver as an electrical signal from a first pedal displacement sensor 11 that detects the displacement of the brake pedal 10 and generates the hydraulic pressure of the pressurized medium through mechanical operation, a hydraulic control unit (also referred to as a hydraulic control device) 1400 that controls the hydraulic pressure provided from the hydraulic pressure supply device 1300, reservoir flow paths 1710, 1720, and 1730 that hydraulically connect the reservoir 300 and the integrated master cylinder 1200 and hydraulically connect the reservoir 300 and the auxiliary brake module 200, a dump control unit 1800 that is provided between the hydraulic pressure supply device 1300 and the reservoir 300 and controls the flow of the pressurized medium, and an inspection flow path 1900 provided to connect the integrated master cylinder 1200 and the hydraulic pressure supply device 1300 and configured to inspect for leaks in various component elements.

When the driver applies the stepping force to the brake pedal 10 for braking operation, the integrated master cylinder 1200 provides a reaction force with respect to the stepping force to the driver so as to provide a stable pedal feel, and is designed to pressurize and discharge the pressurized medium accommodated inside by the operation of the brake pedal 10.

An integrated master cylinder 1200 may include a master cylinder that pressurizes and discharges the pressurized medium accommodated inside by the stepping force of the brake pedal 10 and a pedal simulator 1240 that provides a pedal feel to a driver, which may be disposed coaxially within a single cylinder body 1210.

The master cylinder of the integrated master cylinder 1200 may include a cylinder body 1210 forming a chamber on the inside, a first master chamber 1220a formed on the inlet side of the cylinder body 1210 to which the brake pedal 10 is connected, a first master piston 1220 provided in the first master chamber 1220a and connected to the brake pedal 10 so as to be displaceable by the operation of the brake pedal 10, a second master chamber 1230a formed on the cylinder body 1210 on the inner side or the front side (left side based on FIG. 1) of the first master chamber 1220a, and a second master piston 1230 provided in the second master chamber 1230a and provided to be displaceable by the displacement of the first master piston 1220 or the hydraulic pressure of the pressurized medium accommodated in the first master chamber 1220a.

The pedal simulator 1240 is disposed between the first master piston 1220 and the second master piston 1230 to provide pedal feel through an elastic restoring force generated during compression.

The first master chamber 1220a and the second master chamber 1230a may be sequentially formed from the brake pedal 10 side (right side based on FIG. 1) to the inside (left side based on FIG. 1) on the cylinder body 1210 of the integrated master cylinder 1200. In addition, the first master piston 1220 and the second master piston 1230 may be respectively provided in the first master chamber 1220a and the second master chamber 1230a to form a hydraulic pressure or a negative pressure in the pressurized medium accommodated in each chamber according to the forward and backward movement.

The cylinder body 1210 may include a large-diameter portion 1211 having a first master chamber 1220a formed on the inside but having a relatively large inner diameter, and a small-diameter portion 1212 having a second master chamber 1230a formed on the inside but having a relatively smaller inner diameter than the large-diameter portion 1211. The large-diameter portion 1211 and the small-diameter portion 1212 of the cylinder body 1210 may be formed integrally.

The first master chamber 1220a may be formed inside the large-diameter portion 1211 on the inlet side or the rear side (right side based on FIG. 1) of the cylinder body 1210, and the first master piston 1220 connected to the brake pedal 10 via an input rod 12 may be accommodated to reciprocally move in the first master chamber 1220a.

In the first master chamber 1220a, the pressurized medium may be introduced and discharged through a first hydraulic port 1280a, a second hydraulic port 1280b, and a third hydraulic port 1280c.

The first hydraulic port 1280a may be connected to the first reservoir flow path 1710, so that pressurized medium may be introduced from the reservoir 300 into the first master chamber 1220a, or the pressurized medium accommodated in the first master chamber 1220a may be discharged to the reservoir 300.

The first master chamber 1220a is connected to the first and second branch flow paths 1910 and 1920 of the inspection flow path 1900 described later, respectively, through the second hydraulic port 1280b and the third hydraulic port 1280d, so that the pressurized medium accommodated in the first master chamber 1220a may be discharged toward the inspection flow path 1900, or the pressurized medium may be introduced into the first master chamber 1220a from the inspection flow path 1900.

The first master piston 1220 of the integrated master cylinder 1200 may be provided to be accommodated in the first master chamber 1220a, and may move forward (in a left direction based on FIG. 1) to pressurize the pressurized medium accommodated in the first master chamber 1220a to form a hydraulic pressure, or move backward (in a right direction based on FIG. 1) to form a negative pressure inside the first master chamber 1220a. The first master piston 1220 may include a first body 1221 formed in a cylindrical shape to be in close contact with an inner peripheral surface of the first master chamber 1220a, and a first flange 1222 which is formed to extend radially at the rear end (right end portion based on FIG. 1) of the first body 1221 and to which an input rod 12 is connected. The first master piston 1220 may be elastically supported by a first piston spring 1220b, and the first piston spring 1220b may be provided such that one end is supported by the front surface (left surface based on FIG. 1) of the first flange 1222 and the other end is supported by the outer surface of the cylinder body 1210.

The first master piston 1220 is provided with a first cut-off hole 1220d that communicates with the first master chamber 1220a and communicates with the third hydraulic port 1280c in a non-operating state, that is, in a state of preparation before displacement occurs. In addition, a first sealing member 1290a that seals the first master chamber 1220a from the outside may be provided between the outer peripheral surface of the first master piston 1220 and the cylinder body 1210. The first sealing member 1290a may be provided to be seated in a receiving groove formed to be recessed on the inner peripheral surface of the cylinder body 1210 and come into contact with the outer peripheral surface of the first master piston 1220, thereby preventing the pressurized medium accommodated in the first master chamber 1220a by the first sealing member 1290a from leaking to the outside and preventing external foreign substances from being introduced into the first master chamber 1220a. The first sealing member 1290a may be provided on the outermost side on the inner peripheral surface of the cylinder body 1210, that is, on the rear side (right side based on FIG. 1) of the third hydraulic port 1280c.

Between the outer peripheral surface of the first master piston 1220 and the cylinder body 1210, a third sealing member 1290c may be provided to block the flow of the pressurized medium introduced into the first master chamber 1220a from the first branch flow path 1910 connected to the third hydraulic port 1280c. The third sealing member 1290c may be seated in a receiving groove formed to be recessed in front of the third hydraulic port 1280c on the inner peripheral surface of the cylinder body 1210 so as to come into contact with the outer peripheral surface of the first master piston 1220. The third sealing member 1290c may be provided in front (left side based on FIG. 1) of the first sealing member 1290a, and may allow the pressurized medium accommodated in the first master chamber 1220a to flow through the third hydraulic port 1280c to the first branch flow path 1910, but may block the flow of the pressurized medium introduced into the first master chamber 1220a from the first branch flow path 1910.

The second master chamber 1230a may be formed inside the small-diameter portion 1212 on the inner or front side (left side based on FIG. 1) of the cylinder body 1210, and the second master piston 1230 may be accommodated to reciprocally move in the second master chamber 1230a.

In the second master chamber 1230a, the pressurized medium may be introduced and discharged through the fourth hydraulic port 1280d and the fifth hydraulic port 1280e. The fourth hydraulic port 1280d may be connected to the second reservoir flow path 1720, so that the pressurized medium contained in the reservoir 300 may be introduced toward the second master chamber 1230a. In addition, the fifth hydraulic port 1280e may be connected to a second connection flow path 1620 described later, so that the pressurized medium contained in the second master chamber 1230a may be discharged toward the second connection flow path 1620 side, and conversely, the pressurized medium may be introduced into the second master chamber 1230a side from the second connection flow path 1620.

The second master piston 1230 may be provided to be accommodated in the second master chamber 1230a, may move forward to form hydraulic pressure of the pressurized medium accommodated in the second master chamber 1230a, and may move backward to form a negative pressure in the second master chamber 1230a. The second master piston 1230 may include a second body 1231 formed in a cylindrical shape so as to be in close contact with the inner peripheral surface of the second master chamber 1230a, and a second flange 1232 formed to extend radially at the rear end (right end based on FIG. 1) of the second body 1231 and disposed inside the first master chamber 1220a. The diameter of the second flange 1232 may be formed to be larger than the diameter of the inner peripheral surface of the second master chamber 1230a. The second master piston 1230 may be elastically supported by a second piston spring (not illustrated), and the second piston spring may be provided such that one end is supported by the front surface (left surface based on FIG. 1) of the second body 1231 and the other end is supported by the inner surface of the cylinder body 1210.

A second sealing member 1290b may be provided between the outer peripheral surface of the second master piston 1230 and the cylinder body 1210 to seal the first master chamber 1220a to the second master chamber 1230a. The second sealing member 1290b may be provided to be seated in a receiving groove formed to be recessed on the inner peripheral surface of the cylinder body 1210 and come into contact with the outer peripheral surface of the second master piston 1230, and the pressurized medium accommodated in the first master chamber 1220a may be prevented from leaking into the second master chamber 1230a by the second sealing member 1290b.

The second master piston 1230 is provided with a second cut-off hole 1230d that communicates with the second master chamber 1230a and communicates with the fourth hydraulic port 1280d and the second reservoir flow path 1720 in the non-operating state, that is, in the state of preparation before displacement occurs. In addition, a fourth sealing member 1290d that blocks the flow of the pressurized medium discharged from the second master chamber 1230a to the second reservoir flow path 1720 connected to the fourth hydraulic port 1280d may be provided between the outer peripheral surface of the second master piston 1230 and the cylinder body 1210. The fourth sealing member 1290d is seated in a receiving groove formed to be recessed in front (left side based on FIG. 1) of the fourth hydraulic port 1280d on the inner peripheral surface of the cylinder body 1210 so as to come into contact with the outer peripheral surface of the second master piston 1230. The fourth sealing member 1290d may be provided in front (left side based on FIG. 1) of the second sealing member 1290b, and may allow the flow of a pressurized medium introduced into the second master chamber 1230a from the second reservoir flow path 1720 connected to the fourth hydraulic port 1280d, but may block the flow of a pressurized medium discharged from the second master chamber 1230a to the fourth hydraulic port 1280d and the second reservoir flow path 1720.

Since the integrated master cylinder 1200 independently includes the first master chamber 1220a and the second master chamber 1230a, it is possible to ensure safety at the time of the failure of a component element. For example, the first master chamber 1220a may be connected to the wheel cylinders 1, 2, 3, and 4 through the inspection flow path 1900, the hydraulic pressure supply device 1300, the hydraulic control unit 1400, and/or the auxiliary brake module 200, and the second master chamber 1230a may be connected to two wheel cylinders 1 and 2 through a second connection flow path 1620 described later. Accordingly, even when a problem such as a leak occurs in any one of the chambers, the vehicle can be braked.

The pedal simulator 1240 may be provided between the first master piston 1220 and the second master piston 1230, and may provide the pedal feel of the brake pedal 10 to the driver through an elastic restoring force of the pedal simulator.

The pedal simulator 1240 may be interposed between the front surface of the first master piston 1220 and the rear surface of the second master piston 1230, and may be made of an elastic material such as compressible and expandable rubber. The pedal simulator 1240 may include a cylindrical body portion at least partially inserted and supported in the front surface of the first master piston 1220, and a tapered portion at least partially inserted and supported in the rear surface of the second master piston 1230, and the diameter of the tapered portion decreases toward the front (left side based on FIG. 1). The pedal simulator 1240 may be stably supported by having at least a portion of both ends inserted into the first master piston 1220. Furthermore, by providing a change in elastic restoring force according to the degree of the stepping force applied to the brake pedal 10 by the tapered portion, it is possible to provide a stable and familiar pedal feel to the driver.

The hydraulic pressure supply device 1300 is provided to receive the braking intention of the driver as an electrical signal from the first pedal displacement sensor 11 that detects the displacement of the brake pedal 10 and generate the hydraulic pressure of the pressurized medium through mechanical operation.

The hydraulic pressure supply device 1300 may include a hydraulic pressure providing unit that provides pressurized medium pressure transmitted to the wheel cylinders 1, 2, 3, and 4, a motor 1360 that generates rotational force by an electric signal of the first pedal displacement sensor 11, and a power conversion unit (not illustrated) that converts the rotational motion of the motor 1360 into linear motion and transmits the linear motion to the hydraulic pressure providing unit.

The hydraulic pressure providing unit of the hydraulic pressure supply device 1300 includes a cylinder block 1310 in which the pressurized medium is accommodated, a hydraulic piston 1320 accommodated in the cylinder block 1310, pressure chambers 1330 and 1340 whose volumes are changed by the operation of the hydraulic piston 1320, and a drive shaft 1390 that transmits power output from the power conversion unit to the hydraulic piston 1320.

The first pressure chamber 1330 may be provided on the front side (left direction of the hydraulic piston 1320 based on FIG. 1) of the hydraulic piston 1320. The second pressure chamber 1340 may be provided on the rear side (right direction of the hydraulic piston 1320 based on FIG. 1) of the hydraulic piston 1320. That is, the first pressure chamber 1330 may be provided to be partitioned by the cylinder block 1310 and the front surface of the hydraulic piston 1320 so that the volume of the first pressure chamber is changed depending on the forward and backward movement of the hydraulic piston 1320. The second pressure chamber 1340 is provided to be partitioned by the cylinder block 1310 and the rear surface of the hydraulic piston 1320 so that the volume of the second pressure chamber is changed depending on the forward and backward movement of the hydraulic piston 1320. The first pressure chamber 1330 is connected to a first hydraulic flow path 1401 described later through a communication hole formed in the cylinder block 1310, and the second pressure chamber 1340 is connected to a second hydraulic flow path 1402 described later through a communication hole formed in the cylinder block 1310.

A sealing member is provided between the hydraulic piston 1320 and the cylinder block 1310 to seal the first and second pressure chambers 1330 and 1340 and the openings of the cylinder block 1310, so that the hydraulic pressure or negative pressure of the first and second pressure chambers 1330 and 1340 generated by the forward or backward movement of the hydraulic piston 1320 does not leak to the outside and may be transmitted to the hydraulic control unit 1400 and the dump control unit 1800 described later.

The motor 1360 is provided to generate a driving force of the hydraulic piston 1320 by an electric signal output from the first control circuit 4100. The motor 1360 may be provided including a stator and a rotor, and may provide power to generate displacement of the hydraulic piston 1320 by rotating in a forward or reverse direction through the stator and rotor. The rotational angular velocity and rotational angle of the motor 1360 may be precisely controlled by a motor control sensor (not illustrated). Since the motor 1360 is a widely known technology, a detailed description thereof will be omitted.

The power conversion unit of the hydraulic pressure supply device 1300 is provided to convert the rotational force of the motor 1360 into linear motion. For example, the power conversion unit may be provided with a structure including a worm shaft (not illustrated), a worm wheel (not illustrated), and a drive shaft 1390.

The worm shaft may be formed integrally with the rotation shaft of the motor 1360, and a worm may be formed on the outer peripheral surface of the worm shaft to engage with the worm wheel and rotate the worm wheel. The worm wheel may be connected to engage with the drive shaft 1390 to move the drive shaft 1390 in a linear manner, and the drive shaft 1390 may be connected to the hydraulic piston 1320 to operate integrally, thereby allowing the hydraulic piston 1320 to slide within the cylinder block 1310.

To explain the above operations again, when the displacement of the brake pedal 10 is detected by the first pedal displacement sensor 11, the detected signal is transmitted to the first control circuit 4100, and the first control circuit 4100 drives the motor 1360 to rotate the worm shaft in one direction. The rotational force of the worm shaft may be transmitted to the drive shaft 1390 through the worm wheel, and the hydraulic piston 1320 connected to the drive shaft 1390 may generate hydraulic pressure in the pressure chamber 1330 while moving forward within the cylinder block 1310.

Conversely, when the stepping force of the brake pedal 10 is released, the first control circuit 4100 drives the motor 1360 to rotate the worm shaft in the opposite direction. Accordingly, the worm wheel also rotates in the opposite direction, and the hydraulic piston 1320 connected to the drive shaft 1390 moves backward within the cylinder block 1310, thereby generating the negative pressure in the pressure chamber 1330.

The hydraulic pressure supply device 1300 may be hydraulically connected to the reservoir 300 by the dump control unit 1800.

The hydraulic control unit 1400 may be provided to control the flow of the pressurized medium from the hydraulic pressure supply device 1300 to each of the wheel cylinders 1, 2, 3, and 4 or the flow of the pressurized medium collected from each of the wheel cylinders 1, 2, 3, and 4 to the hydraulic pressure supply device 1300. To this end, the hydraulic control unit 1400 may include a plurality of flow paths and a plurality of valves capable of allowing or blocking the flow of the pressurized medium in the plurality of flow paths so as to smoothly control the flow of the pressurized medium or the hydraulic pressure. In addition, the hydraulic control unit 1400 may include first and second hydraulic circuits 1500 and 1600 that control the flow of hydraulic pressure transmitted to the wheel cylinders 1, 2, 3, and 4 to which the hydraulic pressure of the pressurized medium is transmitted to perform braking of each of the wheels w1, w2, w3, and w4.

The hydraulic control unit 1400 may include first to tenth hydraulic flow paths 1401, 1402, 1403, 1404, 1405, 1406, 1407, 1408, 1409, and 1410. The first hydraulic flow path 1401 may be provided to communicate with the first pressure chamber 1330, and the second hydraulic flow path 1402 may be provided to communicate with the second pressure chamber 1340.

The first hydraulic flow path 1401 and the second hydraulic flow path 1402 may be joined to the third hydraulic flow path 1403, and then branched again to the fourth hydraulic flow path 1404 connected to the first hydraulic circuit 1500 and the fifth hydraulic flow path 1405 connected to the second hydraulic circuit 1600.

The sixth hydraulic flow path 1406 may be provided to communicate with the first hydraulic circuit 1500, and the seventh hydraulic flow path 1407 may be provided to communicate with the second hydraulic circuit 1600. The sixth hydraulic flow path 1406 and the seventh hydraulic flow path 1407 may be joined to the eighth hydraulic flow path 1408, and then branched again to the ninth hydraulic flow path 1409 communicating with the first pressure chamber 1330, and the tenth hydraulic flow path 1410 communicating with the second pressure chamber 1340.

A first valve 1431 for controlling the flow of a pressurized medium may be provided in the first hydraulic flow path 1401. The first valve 1431 may be provided as a check valve for allowing the flow of the pressurized medium discharged from the first pressure chamber 1330 but blocking the flow of the pressurized medium in the opposite direction. In addition, a second valve 1432 for controlling the flow of a pressurized medium may be provided in the second hydraulic flow path 1402, and the second valve 1432 may be provided as a check valve for allowing the flow of the pressurized medium discharged from the second pressure chamber 1340 but blocking the flow of the pressurized medium in the opposite direction.

The fourth hydraulic flow path 1404 is branched from the third hydraulic flow path 1403 where the first hydraulic flow path 1401 and the second hydraulic flow path 1402 are joined to each other and connected to the first hydraulic circuit 1510. The third hydraulic flow path 1403 may be provided with a third valve 1433 that controls the flow of the pressurized medium. The third valve 1433 may be provided as a check valve that allows only the flow of the pressurized medium from the third hydraulic flow path 1403 toward the first hydraulic circuit 1500 and blocks the flow of the pressurized medium in the opposite direction.

The fifth hydraulic flow path 1405 is branched from the third hydraulic flow path 1403 where the first hydraulic flow path 1401 and the second hydraulic flow path 1402 are joined to each other and connected to the second hydraulic circuit 1600. The fifth hydraulic flow path 1405 may be provided with the fourth valve 1434 that controls the flow of the pressurized medium. The fourth valve 1434 may be provided as a check valve that allows only the flow of the pressurized medium from the third hydraulic flow path 1403 toward the second hydraulic circuit 1600 and blocks the flow of the pressurized medium in the opposite direction.

The sixth hydraulic flow path 1406 communicates with the first hydraulic circuit 1500, and the seventh hydraulic flow path 1407 communicates with the second hydraulic circuit 1600 and is provided to be joined into the eighth hydraulic flow path 1408. The sixth hydraulic flow path 1406 may be provided with a fifth valve 1435 for controlling the flow of the pressurized medium. The fifth valve 1435 may be provided as a check valve that allows only the flow of the pressurized medium discharged from the first hydraulic circuit 1500 and blocks the flow of the pressurized medium in the opposite direction. In addition, the seventh hydraulic flow path 1407 may be provided with a sixth valve 1436 for controlling the flow of the pressurized medium. The sixth valve 1436 may be provided as a check valve that allows only the flow of the pressurized medium discharged from the second hydraulic circuit 1600 and blocks the flow of a pressurized medium in the opposite direction.

The ninth hydraulic flow path 1409 is branched from the eighth hydraulic flow path 1408 where the sixth hydraulic flow path 1406 and the seventh hydraulic flow path 1407 are joined to each other and connected to the first pressure chamber 1330. The ninth hydraulic flow path 1409 may be provided with a seventh valve 1437 for controlling the flow of the pressurized medium. The seventh valve 1437 may be provided as a bidirectional control valve for controlling the flow of the pressurized medium transmitted along the ninth hydraulic flow path 1409. The seventh valve 1437 may be provided as a normally closed type solenoid valve.

The tenth hydraulic flow path 1410 is branched from the eighth hydraulic flow path 1408 where the sixth hydraulic flow path 1406 and the seventh hydraulic flow path 1407 are joined to each other and is connected to the second pressure chamber 1340. The tenth hydraulic flow path 1410 may be provided with an eighth valve 1438 for controlling the flow of the pressurized medium. The eighth valve 1438 may be provided as a bidirectional control valve for controlling the flow of the pressurized medium transmitted along the tenth hydraulic flow path 1410. The eighth valve 1438 may be provided as a normally closed type solenoid valve.

According to the above-described plurality of hydraulic flow paths and plurality of valves, the hydraulic pressure formed in the first pressure chamber 1330 by the forward movement of the hydraulic piston 1320 may be sequentially transmitted to the first hydraulic circuit 1500 through the first hydraulic flow path 1401, the third hydraulic flow path 1403, and the fourth hydraulic flow path 1404, and may be sequentially transmitted to the second hydraulic circuit 1600 through the first hydraulic flow path 1401 and the fifth hydraulic flow path 1405. In addition, the hydraulic pressure formed in the second pressure chamber 1340 according to the backward movement of the hydraulic piston 1320 may be sequentially transmitted to the first hydraulic circuit 1500 through the second hydraulic flow path 1402 and the fourth hydraulic flow path 1404, and may be sequentially transmitted to the second hydraulic circuit 1600 through the second hydraulic flow path 1402, the third hydraulic flow path 1403, and the fifth hydraulic flow path 1405.

Conversely, the negative pressure formed in the first pressure chamber 1330 by the backward movement of the hydraulic piston 1320 may cause the pressurized medium provided to the first hydraulic circuit 1510 to be sequentially collected to the first pressure chamber 1330 through the sixth hydraulic flow path 1406, the eighth hydraulic flow path 1408, and the ninth hydraulic flow path 1409, and may cause the pressurized medium provided to the second hydraulic circuit 1600 to be sequentially collected to the first pressure chamber 1330 through the seventh hydraulic flow path 1407, the eighth hydraulic flow path 1408, and the ninth hydraulic flow path 1409. In addition, the negative pressure formed in the second pressure chamber 1340 by the forward movement of the hydraulic piston 1320 may cause the pressurized medium provided to the first hydraulic circuit 1500 to be sequentially collected to the first pressure chamber 1340 through the sixth hydraulic flow path 1406, the eighth hydraulic flow path 1408, and the tenth hydraulic flow path 1410, and may cause the pressurized medium provided to the second hydraulic circuit 1600 to be sequentially collected to the second pressure chamber 1340 through the seventh hydraulic flow path 1407, the eighth hydraulic flow path 1408, and the tenth hydraulic flow path 1410.

The first hydraulic circuit 1500 may regulate and control the hydraulic pressure applied to the first and third wheel cylinders 1 and 3, and the second hydraulic circuit 1600 may regulate and control the hydraulic pressure applied to the second and fourth wheel cylinders 2 and 4.

The first hydraulic circuit 1500 may be provided with a first inlet valve 1501a disposed on the upstream side of the first wheel cylinder 1 to control the flow and hydraulic pressure of the pressurized medium transmitted to the first wheel cylinder 1, and a third inlet valve 1501b disposed on the upstream side of the third wheel cylinder 3 to control the flow and hydraulic pressure of the pressurized medium transmitted to the third wheel cylinder 3. The first and third inlet valves 1501a and 1501b may be normally open type solenoid valves.

Additionally, the first hydraulic circuit 1500 may include first and third outlet valves 1701a and 1502a for controlling the flow of the pressurized medium discharged from the first and third wheel cylinders 1 and 3 to improve performance when the braking of the first and third wheel cylinders 1 and 3 is released.

The first outlet valve 1701a is connected (or provided) to a first connection flow path 1610 described later, which corresponds to the discharge side of the first wheel cylinder 1, so as to control the flow of the pressurized medium between the first wheel cylinder 1 and the integrated master cylinder 1200. For example, the first outlet valve 1701a may be provided as a normally open type solenoid valve.

The third outlet valve 1502a may be provided on the discharge side of the third wheel cylinder 3 and may control the flow of the pressurized medium transmitted from the third wheel cylinder 3 to the reservoir 300, more specifically, to a first reservoir chamber 3101 of the reservoir 300. For example, the third outlet valve 1502a may be provided as a normally closed type solenoid valve.

The first hydraulic circuit 1500 may include a check valve 1513a connected in parallel to each of the first inlet valve 1501a and the third inlet valve 1501b. Additionally, the first hydraulic circuit 1500 may include a check valve 1513b connected in parallel to the first outlet valve 1701a.

The check valve 1513a of the first inlet valve 1501a may be provided in a bypass flow path connecting the front and rear of the first inlet valve 1501a, and may allow only the flow of the pressurized medium from the first wheel cylinder 1 to the hydraulic pressure supply device 1300, and may block the flow of the pressurized medium from the hydraulic pressure supply device 1300 to the first wheel cylinder 1.

The check valve 1513a of the third inlet valve 1501b may be provided in a bypass flow path connecting the front and rear of the third inlet valve 1501b, and may allow only the flow of the pressurized medium from the third wheel cylinder 3 to the hydraulic pressure supply device 1300, and may block the flow of the pressurized medium from the hydraulic pressure supply device 1300 to the third wheel cylinder 3.

The check valve 1513b of the first outlet valve 1701a may be provided in a bypass flow path connecting the front and rear of the first outlet valve 1701a.

The first inlet valve 1501a, the third inlet valve 1501b, the first outlet valve 1701a, and the third outlet valve 1502a of the first hydraulic circuit 1500 may be provided in the first hydraulic circuit flow path 1503.

The first hydraulic circuit flow path 1503 may be connected or extended from the first connection flow path 1610. The first hydraulic circuit flow path 1503 may join the fourth hydraulic flow path 1404 of the hydraulic control unit 1400 on the upstream side of the first inlet valve 1501a and the third inlet valve 1501b. The first hydraulic circuit flow path 1503 may be connected to the first connection flow path 1610 connected to the downstream side of the first outlet valve 1701a through the first outlet valve 1701a. The first hydraulic circuit flow path 1503 may be branched from the downstream side of the first inlet valve 1501a and the upstream side of the first outlet valve 1701a to be connected to the first wheel cylinder 1. The first hydraulic circuit flow path 1503 may be branched from the downstream side of the third inlet valve 1501b and the upstream side of the third outlet valve 1502a to be connected to the third wheel cylinder 3.

The second hydraulic circuit 1600 may be provided with a second inlet valve 1601a disposed upstream of the second wheel cylinder 2 to control the flow and the hydraulic pressure of the pressurized medium transmitted to the second wheel cylinder 2, and a fourth inlet valve 1601b disposed upstream of the fourth wheel cylinder 4 to control the flow and the hydraulic pressure of the pressurized medium transmitted to the fourth wheel cylinder 4. The second and fourth inlet valves 1601a and 1601b may be normally open type solenoid valves.

The second hydraulic circuit 1600 may include second and fourth outlet valves 1602a and 1602b that control the flow of the pressurized medium discharged from the second and fourth wheel cylinders 2 and 4 to improve performance when the braking of the second and fourth wheel cylinders 2 and 4 is released.

The second outlet valve 1602a may be provided on the discharge side of the second wheel cylinder 2 and may control the flow of the pressurized medium transmitted from the second wheel cylinder 2 to the reservoir 300, more specifically, to a third reservoir chamber 3103 of the reservoir 300. For example, the second outlet valve 1602a may be provided as a normally closed type solenoid valve.

The fourth outlet valve 1602b may be provided on the discharge side of the fourth wheel cylinder 4 and may control the flow of the pressurized medium transmitted from the fourth wheel cylinder 4 to the reservoir 300, more specifically, to the third reservoir chamber 3103 of the reservoir 300. For example, the fourth outlet valve 1602b may be provided as a normally closed type solenoid valve.

The second hydraulic circuit 1600 may include a check valve 1613a connected in parallel to each of the second inlet valve 1601a and the fourth inlet valve 1601b.

The check valve 1613a of the second inlet valve 1601a may be provided in a bypass flow path connecting the front and rear of the second inlet valve 1601a, and may allow only the flow of the pressurized medium from the second wheel cylinder 2 to the hydraulic pressure supply device 1300, and may block the flow of the pressurized medium from the hydraulic pressure supply device 1300 to the second wheel cylinder 2.

The check valve 1613a of the fourth inlet valve 1601b may be provided in a bypass flow path connecting the front and rear of the fourth inlet valve 1601b, and may allow only the flow of the pressurized medium from the fourth wheel cylinder 4 to the hydraulic pressure supply device 1300, and may block the flow of the pressurized medium from the hydraulic pressure supply device 1300 to the fourth wheel cylinder 4.

The second inlet valve 1601a, the fourth inlet valve 1601b, the second outlet valve 1602a, and the fourth outlet valve 1602b may be provided in a second hydraulic circuit flow path 1603.

The second hydraulic circuit flow path 1603 may be branched from the second connection flow path 1620 or connected to the second connection flow path 1620. The second hydraulic circuit flow path 1603 may be connected to the second connection flow path 1620 between the downstream side of the second inlet valve 1601a and the upstream side of the second outlet valve 1602a. The second hydraulic circuit flow path 1603 may be joined to the fifth hydraulic flow path 1405 of the hydraulic control unit 1400 upstream of the second inlet valve 1601a and the fourth inlet valve 1601b. The second hydraulic circuit flow path 1603 may be branched between the fourth inlet valve 1601b and the fourth outlet valve 1602b and connected to the fourth wheel cylinder 4.

The first connection flow path 1610 of the main brake module 100 may be provided to connect the first master chamber 1220a of the integrated master cylinder 1200 and the first hydraulic circuit 1500, and the second connection flow path 1620 may be provided to connect the second master chamber 1230a of the integrated master cylinder 1200 and the second hydraulic circuit 1600.

The first connection flow path 1610 may be provided to connect the discharge side of a simulator valve 1711 provided in the first reservoir flow path 1710 described later and the first wheel cylinder 1. For example, the first connection flow path 1610 may communicate with the first wheel cylinder 1 through the first outlet valve 1701a and the auxiliary brake module 200, so that the discharge side of the simulator valve 1711 provided in the first reservoir flow path 1710 and the first wheel cylinder 1 may be connected.

The second connection flow path 1620 may be provided to connect the fifth hydraulic port 1280e and the second wheel cylinder 2. For example, the second connection flow path 1620 may communicate to the second wheel cylinder 2 through the auxiliary brake module 200, thereby connecting the fifth hydraulic port 1280e and the second wheel cylinder 2.

A cut valve 172a for controlling the bidirectional flow of the pressurized medium may be provided in the second connection flow path 1620. For example, the cut valve 172a may be provided as a normally open type solenoid valve.

The reservoir flow path 1700 may be provided to connect the integrated master cylinder 1200 and the reservoir 300.

The reservoir flow path 1700 may include a first reservoir flow path 1710 connecting the first master chamber 1220a and the first reservoir chamber 3101 of the reservoir 300, and a second reservoir flow path 1720 connecting the second master chamber 1230a and the third reservoir chamber 3103 of the reservoir 300.

One end of the first reservoir flow path 1710 may communicate with the first master chamber 1220a by the first hydraulic port 1280a of the integrated master cylinder 1200, and the other end may communicate with the first reservoir chamber 3101 of the reservoir 300. The simulator valve 1711 may be provided in the first reservoir flow path 1710, so that the flow of the pressurized medium between the reservoir 300 and the first master chamber 1220a through the first reservoir flow path 1710 may be controlled.

One end of the second reservoir flow path 1720 may communicate with the second master chamber 1230a by the fourth hydraulic port 1280d of the integrated master cylinder 1200, and the other end may communicate with the reservoir 300.

One end of the third reservoir flow path 1730 may be connected to auxiliary supply flow paths 2641 and 2642 which are connected to a pair of pumps 2620 of the auxiliary brake module 200 described later.

The dump control unit 1800 may include at least one flow path and at least one valve to control the flow of the pressurized medium between the hydraulic pressure supply device 1300 and the reservoir 300.

The dump control unit 1800 may include a first dump control unit that controls the flow of the pressurized medium between the second pressure chamber 1340 and the first reservoir chamber 3101 of the reservoir 300, and a second dump control unit that controls the flow of the pressurized medium between the first pressure chamber 1330 and the second reservoir chamber 3102 of the reservoir 300.

The first dump control unit may include a first dump flow path 1810 connecting the second pressure chamber 1340 and the reservoir 300, and a first bypass flow path 1830 branching off and then rejoining on the first dump flow path 1810. The second dump control unit may include a second dump flow path 1820 connecting the first pressure chamber 1330 and the reservoir 300, and a second bypass flow path 1840 branching off and then rejoining on the second dump flow path 1820.

A first dump check valve 1811 and a first dump valve 1831 for controlling the flow of the pressurized medium may be respectively provided in the first dump flow path 1810 and the first bypass flow path 1830. The first dump check valve 1811 may be provided to allow only the flow of the pressurized medium from the reservoir 300 toward the second pressure chamber 1330 and block the flow of the pressurized medium in the opposite direction. In the first dump flow path 1810, the first bypass flow path 1830 may be connected in parallel to the first dump check valve 1811, and in the first bypass flow path 1830, the first dump valve 1831 for controlling the flow of the pressurized medium between the first pressure chamber 1330 and the reservoir 300 may be provided. In other words, the first bypass flow path 1830 may be connected to bypass the front and rear ends of the first dump check valve 1811 on the first dump flow path 1810, and the first dump valve 1831 may be provided as a bidirectional solenoid valve that controls the flow of the pressurized medium between the first pressure chamber 1330 and the reservoir 300. The first dump valve 1831 may be provided as a normally open type solenoid valve.

A second dump check valve 1821 and a second dump valve 1841 for controlling the flow of the pressurized medium may be respectively provided in the second dump flow path 1820 and the second bypass flow path 1840. The second dump check valve 1821 may be provided to allow only the flow of the pressurized medium from the reservoir 300 toward the first pressure chamber 1330 and block the flow of the pressurized medium in the opposite direction. In the second dump flow path 1820, the second bypass flow path 1840 may be connected in parallel to the second dump check valve 1821, and in the second bypass flow path 1840, the second dump valve 1841 for controlling the flow of the pressurized medium between the first pressure chamber 1330 and the reservoir 300 may be provided. In other words, the second bypass flow path 1840 may be connected to bypass the front and rear ends of the second dump check valve 1821 on the second dump flow path 1820, and the second dump valve 1841 may be provided as a bidirectional solenoid valve that controls the flow of the pressurized medium between the first pressure chamber 1330 and the reservoir 300. The second dump valve 1841 may be provided as a normally closed type solenoid valve.

The inspection flow path 1900 is provided to connect the integrated master cylinder 1200 and the hydraulic pressure supply device 1300, and is provided to inspect the leaks of the various component elements mounted on the integrated master cylinder 1200 and the simulator valve 1711.

The inspection flow path 1900 has one end connected to the second pressure chamber 1340, and the other end branches into the first branch flow path 1910 and the second branch flow path 1920 and may be connected to the first master chamber 1220a through the second hydraulic port 1280b and the third hydraulic port 1280c, respectively.

For example, an inspection valve 1911 may be provided in the first branch flow path 1910 to control the flow of the pressurized medium in both directions between the first master chamber 1220a and the second pressure chamber 1340. An inspection check valve 1921 may be provided in the second branch flow path 1920 to allow only the flow of the pressurized medium from the first master chamber 1220a to the second pressure chamber 1340, and block the flow of the pressurized medium in the opposite direction.

One end of the inspection flow path 1900 may be connected to the second pressure chamber 1340 via the first dump control unit 1810 as illustrated in FIG. 1, but may be connected directly to the second pressure chamber 1340 differently from FIG. 1.

The main brake module 100 may further include a circuit pressure sensor PS1 that detects the hydraulic pressure of the pressurized medium provided by the hydraulic pressure supply device 1300 and a cylinder pressure sensor PS2 that detects the hydraulic pressure of the second master chamber 1230a.

The circuit pressure sensor PS1 may be provided on the first hydraulic circuit 1500 side and may detect the hydraulic pressure of the pressurized medium generated and supplied from the hydraulic pressure supply device 1300 and transmitted to the first hydraulic circuit 1510 in the inspection mode. For example, the circuit pressure sensor PS1 may be provided on the fourth hydraulic flow path 1404.

The cylinder pressure sensor PS2 may be provided between the second master chamber 1230a and the cut valve 172a on the second connection flow path 1620 and may detect the hydraulic pressure of the pressurized medium accommodated in the second master chamber 1230a. For example, a signal corresponding to the pressure numerical information of the pressurized medium detected by the circuit pressure sensor PS1 and the cylinder pressure sensor PS2 may be transmitted to the first control circuit 4100, and the first control circuit 4100 may determine whether there is the leak in the integrated master cylinder 1200 or the simulator valve 1711 by comparing the hydraulic pressure numerical value detected by the circuit pressure sensor PS1 with the hydraulic pressure numerical value detected by the cylinder pressure sensor PS2.

Additionally, the main brake module 100 may further include a stroke sensor (not illustrated) that measures the displacement of the hydraulic piston 1320 of the hydraulic pressure supply device 1300, and the stroke sensor may be utilized to check whether there is the leak in the integrated master cylinder 1200 based on the displacement information of the hydraulic piston 1320.

The auxiliary brake module 200 may operate when receiving the braking request from an external controller while the main brake module 100 is inoperable, and generate and provide the hydraulic pressure required for the braking of the first and second wheel cylinders 1 and 2.

The auxiliary brake module 200 includes a pair of pumps 2620 for pressurizing the pressurized medium, a motor 2610 for driving the pair of pumps 2620, a first auxiliary flow path 2103 for transmitting the pressurized medium pressurized by the pumps 2620 to the first wheel cylinder 1, a second auxiliary flow path 2203 for transmitting the pressurized medium pressurized by the pumps 2620 to the second wheel cylinder 2, a first auxiliary supply flow path 2641 and a second auxiliary supply flow path 2642 provided to supply the pressurized medium to each of the pair of pumps 2620, a first accumulator 2701 connected to the first auxiliary supply flow path 2641, a second accumulator 2702 connected to the second auxiliary supply flow path 2642, a first auxiliary supply valve 2641a provided in the first auxiliary supply flow path 2641 and controlling the supply of the pressurized medium to the pump 2620, a second auxiliary supply valve 2642a provided in a second auxiliary supply flow path 2642 and controlling the supply of the pressurized medium to the pump 2620, a first auxiliary connection flow path 2100 hydraulically connected to the first connection flow path 1610, a second auxiliary connection flow path 2200 hydraulically connected to the second connection flow path 1620, a first pressure regulating valve 2101 provided in the first auxiliary connection flow path 2100 and regulating the pressure of the first auxiliary supply flow path 2641, a second pressure regulating valve 2201 provided in the second auxiliary connection flow path 2200 and regulating the pressure of the second auxiliary supply flow path 2642, a first check valve 2101a connected in parallel to the first pressure regulating valve 2101, and/or a second check valve 2201a connected in parallel to the second pressure regulating valve 2201.

The pair of pumps 2620 may pressurize the pressurized medium according to the reciprocating movement of a piston (not illustrated) provided in a motor 2610. The pair of pumps 2620 receive the pressurized medium from the first auxiliary supply flow path 2641 and the second auxiliary supply flow path 2642, and pressurize the pressurized medium to the level of the hydraulic pressure required for braking by the operation of the motor 2610.

For example, the pressurized medium transmitted from the first auxiliary supply flow path 2641 to the pump 2620 may include the pressurized medium temporarily stored in the first accumulator 2701 described later and/or the pressurized medium supplied through the first connection flow path 1610 (and/or the first auxiliary connection flow path 2100).

Additionally, the pressurized medium transmitted from the second auxiliary supply flow path 2642 to the pump 2620 may include the pressurized medium temporarily stored in the second accumulator 2702 described later and/or the pressurized medium supplied via the second connection flow path 1620 (and/or the second auxiliary connection flow path 2200).

The pressurized medium having the hydraulic pressure formed by one pump 2620 (or, also referred to as a first pump) of the pair of pumps 2620 may be transmitted to the first wheel cylinder 1 by the first auxiliary flow path 2103 provided as a discharge-side flow path of the pump 2620. To this end, the first auxiliary flow path 2103 may have an inlet-side end portion connected to the discharge side of the pump 2620 and an outlet-side end portion connected to the first wheel cylinder 1.

The pressurized medium having the hydraulic pressure formed by the other pump 2620 (also referred to as the second pump) of the pair of pumps 2620 may be transmitted to the second wheel cylinder 2 by the second auxiliary flow path 2203 provided as the discharge-side flow path of the pump 2620. To this end, the second auxiliary flow path 2203 may have an inlet-side end portion connected to the discharge side of the pump 2620 and an outlet-side end portion connected to the second wheel cylinder 2.

The first auxiliary supply flow path 2641 may have one end portion connected to the inlet end side of the pump 2620 and may be connected to the first auxiliary flow path 2103. Additionally, the other end portion of the first auxiliary supply flow path 2641 may be connected to the first auxiliary connection flow path 2100.

The second auxiliary supply flow path 2642 may have one end portion connected to the inlet end side of the pump 2620 and may be connected to the second auxiliary flow path 2203. Additionally, the other end portion of the second auxiliary supply flow path 2642 may be connected to the second auxiliary connection flow path 2200.

The first accumulator 2701 may be connected to the first auxiliary supply flow path 2641 and may temporarily store the pressurized medium discharged from the first wheel cylinder 1. The pressurized medium temporarily stored in the first accumulator 2701 may be transmitted to the suction end of the pump 2620 and resupplied to the first wheel cylinder 1.

The second accumulator 2702 may be connected to the second auxiliary supply flow path 2642 and may temporarily store the pressurized medium discharged from the second wheel cylinder 2. The pressurized medium temporarily stored in the second accumulator 2702 may be transmitted to the suction end of the pump 2620 and resupplied to the second wheel cylinder 2.

By temporarily storing the pressurized medium in the first accumulator 2701 and the second accumulator 2702 and resupplying the pressurized medium to the pump 2620, the suction resistance of the pump 2620 may be reduced. In addition, the first accumulator 2701 and the second accumulator 2702 may suppress a rapid increase in the suction-side hydraulic pressure of the pump 2620, thereby enabling the pump 2620 to be driven more stably.

The first auxiliary supply valve 2641a is provided in the first auxiliary supply flow path 2641 to control the flow of the pressurized medium supplied to the pump 2620. For example, the first auxiliary supply valve 2641a may be provided between the first accumulator 2701 and the pump 2602 in the first auxiliary supply flow path 2641.

The second auxiliary supply valve 2642a is provided in the second auxiliary supply flow path 2642 to control the flow of the pressurized medium supplied to the pump 2620. For example, the second auxiliary supply valve 2642a may be provided between the second accumulator 2702 and the pump 2602 in the second auxiliary supply flow path 2642.

The first auxiliary supply valve 2641a and the second auxiliary supply valve 2642a may be provided as normally closed type solenoid valves.

Meanwhile, the first auxiliary connection flow path 2100 is extended to the first connection flow path 1610 and may be referred to as a part of the first connection flow path 1610, that is, the first connection flow path 1610. In addition, the second auxiliary connection flow path 2200 is extended to the second connection flow path 1620 and may be referred to as a part of the second connection flow path 1620, that is, the second connection flow path 1620.

The first pressure regulating valve 2101 may be provided in the first auxiliary connection flow path 2100, and a second pressure regulating valve 2201 may be provided in the second auxiliary connection flow path 2200.

The first pressure regulating valve 2101 may control the pressure of the first auxiliary supply flow path 2103 by regulating the cutoff pressure according to an electrical signal (or also referred to as current) from the second control circuit 4500.

The second pressure regulating valve 2201 may control the pressure of the second auxiliary supply flow path 2203 by regulating the cutoff pressure according to the electrical signal (or current) from the second control circuit 4500.

The first pressure regulating valve 2101 and the second pressure regulating valve 2201 may be normally open type solenoid valves.

The first check valve 2101a connected in parallel to the first pressure regulating valve 2101 and the second check valve 2201a connected in parallel to the second pressure regulating valve 2201 may allow the pressurized medium to flow in one direction and prevent backflow in the opposite direction, and may be controlled according to an electrical signal from the second control circuit 4500.

The reservoir 300 may accommodate and store the pressurized medium inside. The reservoir 300 may be hydraulically connected to at least one component of the main brake module 100 and at least one component of the auxiliary brake module 200.

The reservoir 300 may be provided by being divided into multiple chambers by a partition 3105.

The reservoir 300 may include a plurality of reservoir chambers 1101, 1102, and 1103, and the plurality of reservoir chambers 1101, 1102, and 1103 may be disposed in a row. For example, the first reservoir chamber 3101, the second reservoir chamber 3102, and the third reservoir chamber 3103 may be disposed in a row from one side to the other.

The first reservoir chamber 3101 may be connected to the integrated master cylinder 1200 by communicating with the first reservoir flow path 1710, and may supply the pressurized medium to the first master chamber 1220a side of the integrated master cylinder 1200 or receive the pressurized medium from the first master chamber 1220a. In addition, the first reservoir chamber 3101 may be hydraulically connected to the dump control unit 1800 and the hydraulic circuit 1510.

The second reservoir chamber 3102 may be hydraulically connected to the dump control unit 1800.

The third reservoir chamber 3103 may be connected to the integrated master cylinder 1200 by communicating with the second reservoir flow path 1720. For example, the third reservoir chamber 3103 may supply the pressurized medium to the second master chamber 1230a of the integrated master cylinder 1200 or receive the pressurized medium from the second master chamber 1230a through the second reservoir flow path 1720 and the fourth hydraulic port 1280d of the integrated master cylinder 1200 connected to the second reservoir flow path 1720. In addition, the third reservoir chamber 3103 may be hydraulically connected to the second hydraulic circuit 1600.

The partition 3105 may be provided between adjacent reservoir chambers, respectively. At least a portion of the upper end of each partition 3105 may be opened, so that adjacent reservoir chambers 1101, 1102, and 1103 may communicate with each other and the pressurized medium may move. For example, when a large amount of pressurized medium is introduced into the first reservoir chamber 3101, the pressurized medium may pass through the upper end of the partition 3105 and be transmitted to the second reservoir chamber 3102 and/or the third reservoir chamber 3103.

In this way, since the reservoir 300 is provided by being divided into the first to third reservoir chambers 1101, 1102, and 1103, stable operation of the electric brake system 1000 may be ensured. For example, when the reservoir 300 is formed as one chamber and the capacity of the pressurized medium is insufficient, the pressurized medium may not be stably supplied not only to the hydraulic pressure supply device 1300, but also to the integrated master cylinder 1200 and the dump control unit 1800. Therefore, by providing the reservoir 300 separately, even when the pressurized medium cannot be supplied to one component element, the braking of the vehicle may be implemented by supplying the pressurized medium to another component element.

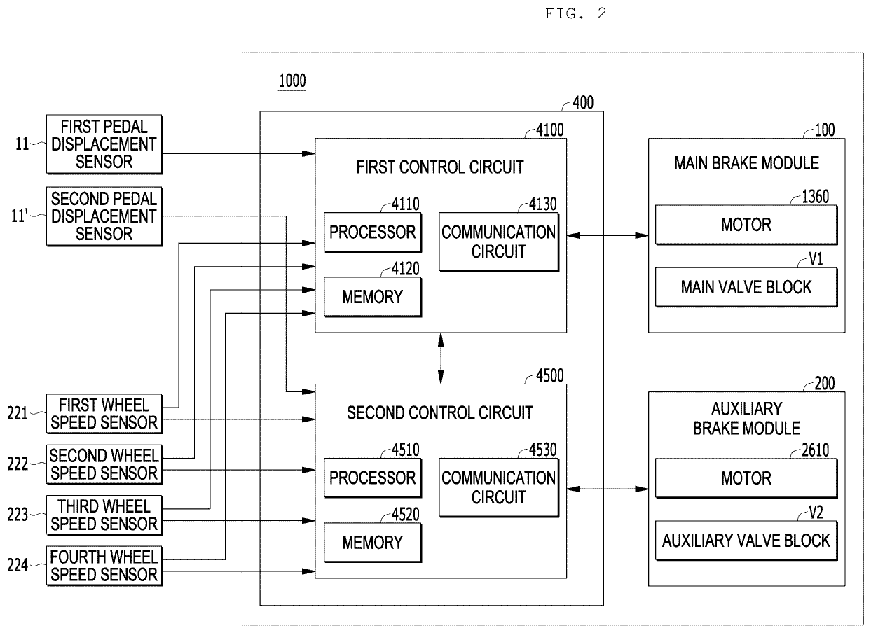

FIG. 2 is a block diagram illustrating the configuration of a control circuit of the electric brake system according to one exemplary embodiment.

Referring to FIG. 2, the electric brake system 1000 may include the main brake module 100, the auxiliary brake module 200, and/or the control circuit 400.

The main brake module 100 may be the main brake module 100 of FIG. 1, and may include a motor 1360 that generates rotational force by the control signal of the first control circuit 4100 that receives an electrical signal of the first pedal displacement sensor 11 for the brake pedal 10, and a main valve block V1 that includes valves included in the main brake module 100 of FIG. 1.

The main valve block V1 may include the simulator valve 1711, the cut valve 172a, the inspection valve 1911, the inspection check valve 1921, the first inlet valve 1501a, the first outlet valve 1701a, the second inlet valve 1601a, the second outlet valve 1602a, the third inlet valve 1501b, the third outlet valve 1502a, the fourth inlet valve 1601b, the fourth outlet valve 1602b, and/or the check valves 1513a, 1513b, and 1613a.

The auxiliary brake module 200 may be the auxiliary brake module 200 of FIG. 1, and may include the motor 2610 of the auxiliary brake module 200 of FIG. 1 and an auxiliary valve block V2 including valves included in the auxiliary brake module 200 of FIG. 1.

The auxiliary valve block V2 may include the first pressure regulating valve 2101, the second pressure regulating valve 2201, the first auxiliary supply valve 2641a, the second auxiliary supply valve 2642a, the first check valve 2101a, and/or a second check valve 2201a.

The control circuit 400 may include the first control circuit 4100 and the second control circuit 4200 of FIG. 1.

The first control circuit 4100 may include a plurality of semiconductor devices and may be named variously, such as an electronic control unit (ECU). The first control circuit 4100 may include, for example, one or more processors 4110, one or more memories 4120, and/or a communication circuit 4130.

The first control circuit 4100 may be electrically or communicatively connected to the second control circuit 4500 through the communication circuit 4130.

The first control circuit 4100 may receive a signal corresponding to the braking intention of the user from the first pedal displacement sensor 11, and in response thereto, may provide an electrical signal for supplying or collecting hydraulic pressure to the wheel cylinders 1, 2, 3, and 4 to the hydraulic pressure supply device 1300 and the hydraulic control unit 1400, respectively.

The first control circuit 4100 may receive signals corresponding to the rotation speeds of the respective wheels from a first wheel speed sensor 221 provided on the first wheel w1, a second wheel speed sensor 222 provided on the second wheel w2, a third wheel speed sensor 223 provided on the third wheel w3, and a fourth wheel speed sensor 224 provided on the fourth wheel w4. In addition, the first control circuit 4100 may, in response to receiving signals corresponding to the rotation speeds of the respective wheels from the respective wheel speed sensors 221, 222, 223, and 224, provide electrical signals for supplying or collecting hydraulic pressure to each of the wheel cylinders 1, 2, 3, and 4 to the hydraulic pressure supply device 1300 and the hydraulic control unit 1400 to realize an anti-lock braking system (ABS).

For example, the first control circuit 4100 may receive a signal corresponding to the braking intention of the user from the first pedal displacement sensor 11, and in response thereto, control at least one valve and/or motor 1360 of the main valve block V1.

The first control circuit 4100 may switch the electric brake system 1000 from a normal mode to a fallback mode when the hydraulic pressure supply device 1300 is inoperable, and may transmit a signal indicating the switch to the fallback mode to the second control circuit 4500. The fallback mode means that the electric brake system 1000 maintains a minimum braking function in response to abnormal operation of the main brake module 100.

The second control circuit 4500 may include a plurality of semiconductor devices and may be named variously, such as an electronic control unit (ECU). The second control circuit 4500 may include, for example, one or more processors 4510, one or more memories 4520, and/or a communication circuit 4530.

The second control circuit 4500 may be electrically or communicatively connected to the first control circuit 4100 through the communication circuit 4530.

The second control circuit 4500 may identify whether the first control circuit 4100 is normal or abnormal, that is, inoperable, through communication with the first control circuit 4100 via the communication circuit 4530, for example, based on reception of a signal from the first control circuit 4100. In addition, the second control circuit 4500 may identify whether one component element of the main brake module 100 is normal or inoperable, through communication with the first control circuit 4100, for example, based on reception of a signal from the first control circuit 4100.

The second control circuit 4500 may receive a signal indicating a switch to the fallback mode of the electric brake system 1000 via the communication circuit 4500.

In the fallback mode, the first pressure regulating valve 2101 and the second pressure regulating valve 2201, which are normally open type solenoid valves, remain in the open state, and the first auxiliary supply valve 2641a and the second auxiliary supply valve 2642a, which are normally closed type solenoid valves, remain in the closed state.

In this state, when the brake pedal 10 is pressed, the pressurized medium may be supplied from the integrated master cylinder 1200 to the first wheel cylinder 1 and the third wheel cylinder 3 through the first connection flow path 1610, and the pressurized medium may be supplied to the second wheel cylinder 2 and the fourth wheel cylinder 4 through the second connection flow path 1620.

The second control circuit 4500 may control at least one valve of the auxiliary valve block V2 and/or the motor 2610 at the time of the braking request (or also referred to as a demand deceleration signal) from an external controller while the hydraulic pressure supply device 1300 is inoperable.

The second control circuit 4500 may close the first pressure regulating valve 2101 and the second pressure regulating valve 2201, open the first auxiliary supply valve 2641a and the second auxiliary supply valve 2642a, and drive the motor 2610 at the time of the braking request from an external controller while the hydraulic pressure supply device 1300 is inoperable.

For example, the first control circuit 4100 may transmit the braking request to the second control circuit 4500 based on a signal acquired through at least one sensor (for example, a wheel speed sensor, a camera, or the like) of the vehicle while the hydraulic pressure supply device 1300 is inoperable. Alternatively, a vehicle control circuit (not illustrated) that is communicatively connected or electrically connected to the first control circuit 4100 and the second control circuit 4500 may transmit the braking request to the second control circuit 4500 while the hydraulic pressure supply device 1300 is inoperable.

The second control circuit 4500 may receive the braking request from the first control circuit 4100 or the vehicle control circuit, and in response to this, close the first pressure regulating valve 2101 and the second pressure regulating valve 2201, open the first auxiliary supply valve 2641a and the second auxiliary supply valve 2642a, and drive the motor 2610.

When the motor 2610 is driven while the first pressure regulating valve 2101 is closed and the first auxiliary supply valve 2641a is opened, in a case where the pressurized medium is stored in the first accumulator 2701, the pressurized medium stored in the first accumulator 2701 may be supplied to the pump 2620. For example, the pressurized medium from the main brake module 100 may be supplied to the pump 2620 subsequent to or simultaneously with the pressurized medium stored in the first accumulator 2701 being supplied to the pump 2620.

When the motor 2610 is driven while the second pressure regulating valve 2201 is closed and the second auxiliary supply valve 2642a is opened, in a case where the pressurized medium is stored in the second accumulator 2702, the pressurized medium stored in the second accumulator 2702 may be supplied to the pump 2620. For example, the pressurized medium from the main brake module 100 may be supplied to the pump 2620 subsequent to or simultaneously with the pressurized medium stored in the second accumulator 2702 being supplied to the pump.

Meanwhile, the second control circuit 4500 may control the driving current supplied to the first pressure regulating valve 2101 and the second pressure regulating valve 2201 based on the pressure corresponding to the braking request of the external controller.

The memory 4520 may store driving current information mapped to a plurality of pieces of pressure information.

The second control circuit 4500 may identify pressure information corresponding to a pressure corresponding to the braking request of the external controller from the driving current information mapped to a plurality of pieces of pressure information stored in the memory 4520, and identify driving current information mapped to the identified pressure information.

The second control circuit 4500 may supply current corresponding to the driving current information identified in the first pressure regulating valve 2101 and the second pressure regulating valve 2201. The first pressure regulating valve 2101 and the second pressure regulating valve 2201 may control the pressure of the first auxiliary flow path 2103 and the second auxiliary flow path 2203 by regulating the cutoff pressure according to the supplied driving current. Accordingly, the pressure of the first wheel cylinder 1 and the second wheel cylinder 2 may be controlled.

The second control circuit 4500 may open the first pressure regulating valve 2101 and the second pressure regulating valve 2201 and close the first auxiliary supply valve 2641a and the second auxiliary supply valve 2642a to release the pressure of the pressurized first wheel cylinder 1 and the second wheel cylinder 2 while the hydraulic pressure supply device 1300 is inoperable. In this case, the motor 2610 and the pump 2620 may remain in a non-driven state.

According to the opening of the first pressure regulating valve 2101 and the closing of the first auxiliary supply valve 2641a, the pressurized medium discharged from the first wheel cylinder 1 may be transmitted to the first accumulator 2701 and stored in the first accumulator 2701 through the flow path connecting the first wheel cylinder 1 and the first accumulator 2701, that is, the first auxiliary connection flow path 2100 and the first auxiliary supply flow path 2641.

According to the opening of the second pressure regulating valve 2201 and the closing of the second auxiliary supply valve 2642a, the pressurized medium discharged from the second wheel cylinder 2 may be transmitted to the second accumulator 2702 and stored in the second accumulator 2702 through the flow path connecting the second wheel cylinder 2 and the second accumulator 2702, that is, the second auxiliary connection flow path 2200 and the second auxiliary supply flow path 2642.

For example, the second control circuit 4500 may open the first pressure regulating valve 2101 and the second pressure regulating valve 2201 and close the first auxiliary supply valve 2641a and the second auxiliary supply valve 2642a to release the pressure of the first wheel cylinder 1 and the second wheel cylinder 2 after the pressurized medium is supplied to the first wheel cylinder 1 and the second wheel cylinder 2 based on the driving of the motor 2610. When the second control circuit 4500 controls to release the pressure of the first wheel cylinder 1 and the second wheel cylinder 2, the driving of the motor 2610 may be released. Accordingly, the pressurized medium discharged from the first wheel cylinder 1 and the second wheel cylinder 2 may be transmitted to and stored in the first accumulator 2701 and the second accumulator 2702.

According to the opening of the first pressure regulating valve 2101 and the closing of the first auxiliary supply valve 2641a, the integrated master cylinder 1200 communicates with the first wheel cylinder 1 through the first connection flow path 1610, so that the pressure of the first wheel cylinder 1 may be discharged, that is, the pressure may be released. Accordingly, the pressure of the first and third wheel cylinders 1 and 3 may be discharged through the first connection flow path 1610.

In addition, according to the opening of the second pressure regulating valve 2201 and the closing of the second auxiliary supply valve 2642a, the integrated master cylinder 1200 communicates with the second wheel cylinder 2 through the second connection flow path 1620, so that the pressure of the second wheel cylinder 2 may be discharged, that is, the pressure may be released. Accordingly, the pressure of the second and fourth wheel cylinders 2 and 4 may be discharged through the second connection flow path 1620.

Additionally, according to the opening of the first pressure regulating valve 2101 and the closing of the first auxiliary supply valve 2641a, the first auxiliary flow path 2103, the first auxiliary connection flow path 2100 communicating with the first wheel cylinder 1, and the first hydraulic circuit flow path 1503 provided with the first and third inlet valves 1501a and 1501b in the open state and the first outlet valve 1701a in the open state may communicate with each other. In addition, the flow path communicating with the first hydraulic circuit flow path 1503 and the third wheel cylinder 3 may communicate with each other. In addition, the first auxiliary connection flow path 2100 may communicate with the integrated master cylinder 1200 through the first connection flow path and the first reservoir chamber 3101 of the reservoir 300 through the first bypass flow path 1830.

In addition, according to the opening of the second pressure regulating valve 2201 and the closing of the second auxiliary supply valve 2642a, the second auxiliary flow path 2203, the second auxiliary connection flow path 2200 communicating with the second wheel cylinder 2, the second connection flow path 1620, and the second reservoir flow path 1720 may communicate with each other. In addition, the second connection flow path 1620, the second hydraulic circuit flow path 1603 provided with the second and third inlet valves 1601a and 1601b in the open state and the second and third outlet valves 1602a and 1602b in the closed state, and the flow path communicating with the second hydraulic circuit flow path 1603 and the fourth wheel cylinder 4 may communicate with each other.

Additionally, the lower side of the fourth valve 1434 provided in the fifth hydraulic flow path 1405 from the first hydraulic circuit flow path 1503 and the second hydraulic circuit flow path 1603, the lower side of the third valve 1433 provided in the fourth hydraulic flow path 1404, the seventh hydraulic flow path 1407, the eighth hydraulic flow path 1408, the ninth hydraulic flow path 1409 connecting between the seventh valve 1437 and the eighth valve 1438, and the tenth hydraulic flow path 1410 may communicate with each other.

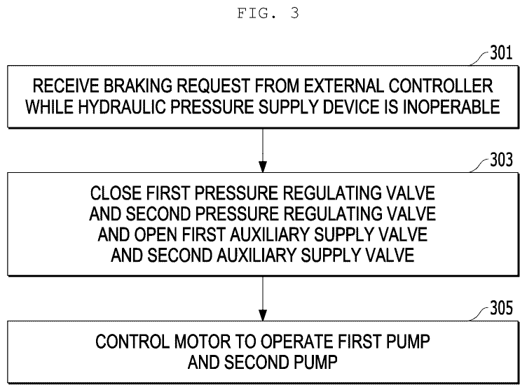

FIG. 3 is a flowchart of the operation of the electric brake system 1000 (and/or a second control circuit 4500) according to one exemplary embodiment.

Referring to FIG. 3, the electric brake system 1000 may receive the braking request from an external controller while the hydraulic pressure supply device 1300 is inoperable (301).

The electric brake system 1000 may close the first pressure regulating valve 2101 and the second pressure regulating valve 2201 and open the first auxiliary supply valve 2641a and the second auxiliary supply valve 2642a based on the reception of the braking request from the external controller while the hydraulic pressure supply device 1300 is inoperable (303).

The electric brake system 1000 may control the motor 2610 to operate the first pump 2620 and the second pump 2620 based on the closing of the first pressure regulating valve 2101 and the second pressure regulating valve 2201 and the opening of the first auxiliary supply valve 2641a and the second auxiliary supply valve 2642a (305).

According to the closing of the first pressure regulating valve 2101 and the opening of the first auxiliary supply valve 2641a, the pressurized medium stored in the first accumulator 2701 may be supplied to the first pump 2620. Additionally, according to the closing of the first pressure regulating valve 2101 and the opening of the first auxiliary supply valve 2641a, the pressurized medium supplied through the first connection flow path 1610 may be further supplied.

According to the closing of the second pressure regulating valve 2201 and the opening of the second auxiliary supply valve 2642a, the pressurized medium stored in the second accumulator 2702 may be supplied to the second pump 2620. Additionally, according to the closing of the second pressure regulating valve 2201 and the opening of the second auxiliary supply valve 2642a, the pressurized medium supplied through the second connection flow path 1620 may be further supplied.

Meanwhile, in addition to the exemplary embodiment of FIG. 3 described above, the electric brake system 1000 may open the first pressure regulating valve 2101 and the second pressure regulating valve 2201 and close the first auxiliary supply valve 2641a and the second auxiliary supply valve 2642a based on receiving the braking request through the brake pedal 10 while the hydraulic pressure supply device 1300 is inoperable. In addition, the electric brake system 1000 may control the motor 2610 to stop the operation of the first pump 2620 and the second pump 2620.

According to the opening of the first pressure regulating valve 2101 and the closing of the first auxiliary supply valve 2641a, the pressurized medium discharged from the first wheel cylinder 1 may be transmitted to the first accumulator 2701 and temporarily stored in the first accumulator 2701.

According to the opening of the second pressure regulating valve 2201 and the closing of the second auxiliary supply valve 2642a, the pressurized medium discharged from the second wheel cylinder 2 may be transmitted to the second accumulator 2702 and temporarily stored in the second accumulator 2702.

The electric brake system 1000 and the control method thereof according to the above-described exemplary embodiments may stably and effectively implement the braking in various operating situations of a vehicle.

In addition, the electric brake system 1000 and the control method thereof may improve braking performance and operational reliability.

In addition, the electric brake system 1000 and the control method thereof may be implemented to perform various braking operation modes through a simple structure and operation.

In addition, the electric brake system 1000 and the control method thereof may improve the assemblability and productivity of the product and reduce the manufacturing cost.

Additionally, the electric brake system 1000 and the control method thereof may reduce the suction resistance of the pump of the auxiliary brake module.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. An electric brake system, comprising:
a hydraulic pressure supply device configured to generate hydraulic pressure of a pressurized medium;
a hydraulic control device provided between the hydraulic pressure supply device and a plurality of wheel cylinders, and configured to transmit the pressurized medium with the hydraulic pressure generated by the hydraulic pressure supply device to the plurality of wheel cylinders; and
an auxiliary brake configured to provide the pressurized medium with the hydraulic pressure to a first wheel cylinder and a second wheel cylinder among the plurality of wheel cylinders,
wherein the auxiliary brake includes:
a first accumulator configured to temporarily store the pressurized medium discharged from the first wheel cylinder,
a first auxiliary supply flow path connected to:
the first accumulator, and
a first connection flow path connecting the hydraulic control device and the first wheel cylinder,
a first pump configured to pressurize the pressurized medium supplied through the first auxiliary supply flow path,
a motor configured to operate the first pump,
a first auxiliary flow path configured to transmit the pressurized medium pressurized by the first pump to the first wheel cylinder,
a first auxiliary supply valve provided in the first auxiliary supply flow path, and configured to control supply of the pressurized medium to the first pump, and
a first pressure regulating valve configured to regulate pressure of the pressurized medium in the first auxiliary flow path.

2. The electric brake system according to claim 1, further comprising:
a control circuit configured to cause closing of the first pressure regulating valve and opening of the first auxiliary supply valve, and to control the motor to operate the first pump, in response to receiving a braking request from an external controller while the hydraulic pressure supply device is inoperable.

3. The electric brake system according to claim 2, wherein the pressurized medium stored in the first accumulator is supplied to the first pump, in response to the closing of the first pressure regulating valve and the opening of the first auxiliary supply valve.

4. The electric brake system according to claim 3, wherein the pressurized medium is further supplied to the first pump through the first connection flow path, in response to the closing of the first pressure regulating valve and the opening of the first auxiliary supply valve.

5. The electric brake system according to claim 2, wherein the control circuit is configured to cause opening of the first pressure regulating valve and closing of the first auxiliary supply valve, and to control the motor to stop operating the first pump, in response to receiving a braking request through a brake pedal while the hydraulic pressure supply device is inoperable.

6. The electric brake system according to claim 5, wherein the pressurized medium discharged from the first wheel cylinder is temporarily stored in the first accumulator, in response to the opening of the first pressure regulating valve and the closing of the first auxiliary supply valve.

7. The electric brake system according to claim 1, wherein
the auxiliary brake further includes:
a second accumulator configured to temporarily store the pressurized medium discharged from the second wheel cylinder,
a second auxiliary supply flow path connected to:
the second accumulator, and
a second connection flow path connecting the hydraulic control device and the second wheel cylinder,
a second pump configured to pressurize the pressurized medium supplied through the second auxiliary supply flow path,
a second auxiliary flow path configured to transmit the pressurized medium pressurized by the second pump to the second wheel cylinder,
a second auxiliary supply valve provided in the second auxiliary supply flow path, and configured to control supply of the pressurized medium to the second pump, and
a second pressure regulating valve configured to regulate the pressure of the pressurized medium in the second auxiliary flow path, and
the motor is further configured to operate the second pump.

8. The electric brake system according to claim 7, further comprising:
a control circuit configured to cause closing of the second pressure regulating valve and opening of the second auxiliary supply valve, and to control the motor to operate the second pump, in response to receiving a braking request from an external controller while the hydraulic pressure supply device is inoperable.

9. The electric brake system according to claim 8, wherein the pressurized medium stored in the second accumulator is supplied to the second pump, in response to the closing of the second pressure regulating valve and the opening of the second auxiliary supply valve.

10. The electric brake system according to claim 9, wherein the pressurized medium is further supplied to the second pump through the second connection flow path, in response to the closing of the second pressure regulating valve and the opening of the second auxiliary supply valve.

11. The electric brake system according to claim 8, wherein the control circuit is configured to cause opening of the second pressure regulating valve and closing of the second auxiliary supply valve, and to control the motor to stop operating the second pump, in response to receiving a braking request through a brake pedal while the hydraulic pressure supply device is inoperable.

12. The electric brake system according to claim 11, wherein the pressurized medium discharged from the second wheel cylinder is temporarily stored in the second accumulator, in response to the opening of the second pressure regulating valve and the closing of the second auxiliary supply valve.

13. The electric brake system according to claim 7, further comprising:
an integrated master cylinder including a first master piston displaceable by operation of a brake pedal,
a first master chamber having a volume variable by displacement of the first master piston,
a second master piston displaceable by the displacement of the first master piston or a hydraulic pressure of the first master chamber, and
a second master chamber having a volume variable by displacement of the second master piston,
wherein the first connection flow path connects the first master chamber and the first wheel cylinder, and
the second connection flow path connects the second master chamber and the second wheel cylinder.

14. The electric brake system according to claim 13, further comprising:
a reservoir;
a first reservoir flow path connecting the first master chamber and the reservoir; and
a second reservoir flow path connecting the second master chamber and the reservoir.

15. The electric brake system according to claim 7, wherein
the first pressure regulating valve is provided in the first connection flow path, and
the second pressure regulating valve is provided in the second connection flow path.

16. A control method of an electric brake system, the electric brake system including:
a hydraulic pressure supply device configured to generate hydraulic pressure of a pressurized medium,
a hydraulic control device provided between the hydraulic pressure supply device and a plurality of wheel cylinders, and configured to transmit the pressurized medium with the hydraulic pressure generated by the hydraulic pressure supply device to the plurality of wheel cylinders,
a first accumulator configured to temporarily store the pressurized medium discharged from a first wheel cylinder among the plurality of wheel cylinders,
a first auxiliary supply flow path connected to:
the first accumulator, and
a first connection flow path connecting the hydraulic control device and the first wheel cylinder,
a first pump configured to pressurize the pressurized medium supplied through the first auxiliary supply flow path,
a motor configured to operate the first pump,
a first auxiliary flow path configured to transmit the pressurized medium pressurized by the first pump to the first wheel cylinder,
a first auxiliary supply valve provided in the first auxiliary supply flow path, and configured to control supply of the pressurized medium to the first pump, and
a first pressure regulating valve configured to regulate pressure of the pressurized medium in the first auxiliary flow path,
the control method comprising:
receiving a braking request from an external controller while the hydraulic pressure supply device is inoperable; and
in response to the braking request,
closing the first pressure regulating valve,
opening the first auxiliary supply valve, and
controlling the motor to operate the first pump.

17. The control method according to claim 16, wherein the pressurized medium stored in the first accumulator is supplied to the first pump, in response to the closing of the first pressure regulating valve and the opening of the first auxiliary supply valve.

18. The control method according to claim 16, wherein the electric brake system further includes:
a second accumulator configured to temporarily store the pressurized medium discharged from a second wheel cylinder among the plurality of wheel cylinders,
a second auxiliary supply flow path connected to:
the second accumulator, and
a second connection flow path connecting the hydraulic control device and the second wheel cylinder,
a second pump configured to pressurize the pressurized medium supplied through the second auxiliary supply flow path, wherein the motor is further configured to operate the second pump,
a second auxiliary flow path configured to transmit the pressurized medium pressurized by the second pump to the second wheel cylinder,
a second auxiliary supply valve provided in the second auxiliary supply flow path, and configured to control supply of the pressurized medium to the second pump, and
a second pressure regulating valve configured to regulate pressure of the pressurized medium in the second auxiliary flow path.

19. The control method according to claim 18, further comprising:
in response to the braking request,
closing the second pressure regulating valve,
opening the second auxiliary supply valve, and
controlling the motor to operate the second pump.

20. The control method according to claim 18, wherein
the pressurized medium discharged from the first wheel cylinder is temporarily stored in the first accumulator, in response to opening of the first pressure regulating valve and closing of the first auxiliary supply valve, and
the pressurized medium discharged from the second wheel cylinder is temporarily stored in the second accumulator, in response to opening of the second pressure regulating valve and closing of the second auxiliary supply valve.
